(19) United States
(12) Patent Application Publication
(10) Pub. No.: US 2018/0109791 A1
(43) Pub. Date: Apr. 19, 2018

(54) A method and a module for self-adaptive motion estimation

(71) Applicant: Peking University Shenzhen Graduate School, Shenzhen (CN)

(72) Inventors: Xufeng Li, Shenzhen (CN); Ronggang Wang, Shenzhen (CN); Zhenyu Wang, Shenzhen (CN); Wenmin Wang, Shenzhen (CN); Wen Gao, Shenzhen (CN)

(21) Appl. No.: 15/567,155

(22) PCT Filed: May 7, 2015
(86) PCT No.: PCT/CN2015/078429

§ 371 Date: Oct. 17, 2017

(51) Int. Cl. H04N 19/119; H04N 19/176; H04N 19/139; H04N 19/55

(52) U.S. Cl. CPC H04N 19/119; H04N 19/176; H04N 19/52; H04N 19/55; H04N 19/139

(57) ABSTRACT

A self-adaptive motion estimation module includes a macro block division unit, a macro block selection unit, a motion intensity judgment unit, and a motion estimation unit. A video frame to be encoded is divided into macro blocks by the macro block division unit. The macro block selection unit sequentially selects an image block in a video frame as the current image block. The motion intensity judgment unit determines a motion intensity of the current image block, and makes a self-adaptive selection of a motion estimation method for performing motion estimation on the current image block according to the motion intensity of the current image block. The motion estimation unit performs motion estimation on the current image block according to the motion estimation method selected by the motion intensity judgment unit. Before motion estimations are performed on the image blocks, motion intensities of image blocks are determined. A method is self-adaptively selected to estimate motion of the current image block according to the motion intensity of the current image block, which improves the efficiency of motion estimation in video encoding and decoding.

### TECHNICAL FIELD

The present invention relates to video encoding and decoding, in particular, to a method and a module for self-adaptive motion estimation.

### BACKGROUND OF THE INVENTION

With the increasing popularity of high-definition digital products such as digital TV, Internet HD video and digital cameras, people are demanding more on video definition, and the resolutions of videos are getting higher and higher. Therefore, the development of a new generation of efficient video coding standards is extremely urgent.

In order to take full advantage of the temporal redundancy of videos, most mainstream video encoding and decoding standards adopt inter-frame prediction to improve the efficiency of compression. Motion estimation is the most important part of inter-frame prediction, which can take up more than half of the encoding time in some video encoding standards. In video coding compression, motion estimation is an effective means to reduce the temporal redundancy of video sequences, and its computation efficiency has a significant effect on the performance of the whole encoding system. Motion estimation algorithms in general include pixel recursive method and block matching method, in which the block matching method is the most commonly used. Among block matching algorithms, Full Search (FS) features the highest precision and has the most computational complexity. In order to increase search speed, many fast algorithms have been proposed to reduce computational complexity at the expense of certain amounts of search precisions. Examples of these fast algorithms include Three Step Search (TSS), Diamond Search (DS) and Hexagon-based Search (HEXBS).

However, with the improvement of resolution, the accuracy and efficiency of motion estimation attract more and more attention. Existing motion estimation methods either are fast but unsuitable for fast-moving scenes, or have high performance but also complexity and low search speeds.

### SUMMARY OF THE INVENTION

The present invention provides a method and a module for self-adaptive motion estimation, which increases search speed in motion estimation as much as possible without affecting the accuracy of motion estimation.

In one aspect, the present invention provides a self-adaptive motion estimation method that includes: dividing a video frame to be encoded into macro blocks by a macro block division unit; sequentially selecting one of the image blocks in the video frame as a current image block by a macro block selection unit; determining a motion intensity of the current image block, and self-adaptively selecting a method to estimate motion of the current image block, by a motion intensity judgment unit, according to the motion intensity of the current image block, wherein the motion intensity characterizes a motion amplitude and/or a motion frequency of an object in the video frame; and performing a motion estimation on the current image block by a motion estimation unit according to the method selected by the motion intensity judgment unit.

In some embodiments, the method can further include: determining, by the motion intensity judgment unit, whether the motion intensity of the current image block satisfies a preset condition; if the preset condition is not satisfied, determining that the motion intensity of the current image block is high, and selecting a first motion estimation method; and if the preset condition is satisfied, determining that the motion intensity of the current image block is low, and selecting a second motion estimation method, wherein the second motion estimation method has a higher search speed than the first motion estimation method.

In some embodiments, the motion intensity of the current image block can be determined according to motion information of the current image block and coded image blocks adjacent to the current image block.

In some embodiments, the motion intensity of the current image block can be determined according to a difference between a predicted motion vector of the current image block and a motion vector of an already coded image block adjacent to the current image block.

In some embodiments, the preset condition can be expressed as:

f(PMV)<TH1 and Σᵢ₌₁³f(MVDi)/3<TH2

wherein TH1 and TH2 are preset thresholds, f is a vector operation function, PMV is a predicted motion vector of the current image block, and MVD is a difference between a predicted motion vector of the current image block and a motion vector of an already coded image block adjacent to the current image block.

According to a further aspect, the present invention provides a computer module for self-adaptive motion estimation that includes: a macro block division unit configured to divide a video frame to be encoded into macro blocks; a macro block selection unit configured to sequentially select one of the image blocks in the video frame as a current image block; a motion intensity judgment unit configured to determine a motion intensity of the current image block, and to self-adaptively select a method to estimate motion of the current image block according to the motion intensity of the current image block, wherein the motion intensity characterizes a motion amplitude and/or a motion frequency of an object in the video frame; and a motion estimation unit configured to perform a motion estimation on the current image block according to the method selected by the motion intensity judgment unit.

In some embodiments, the motion intensity judgment unit can determine whether the motion intensity of the current image block satisfies a preset condition, wherein if the preset condition is not satisfied, the motion intensity judgment unit can determine that the motion intensity of the current image block is high, and selecting a first motion estimation method, wherein if the preset condition is satisfied, the motion intensity judgment unit can determine that the motion intensity of the current image block is low, and selecting a second motion estimation method, wherein the second motion estimation method has a higher search speed than the first motion estimation method.

In some embodiments, the motion intensity of the current image block can be determined by the motion intensity judgment unit according to motion information of the current image block and coded image blocks adjacent to the current image block.

In some embodiments, the motion intensity of the current image block can be determined by the motion intensity judgment unit according to a difference between a predicted motion vector of the current image block and a motion vector of an already coded image block adjacent to the current image block.

In some embodiments, the preset condition can be expressed as:

f(PMV)<TH1 and Σᵢ₌₁³f(MVDi)/3<TH2

wherein TH1 and TH2 are preset thresholds, f is a vector operation function, PMV is a predicted motion vector of the current image block, and MVD is a difference between a predicted motion vector of the current image block and a motion vector of an already coded image block adjacent to the current image block.

The method and the module for self-adaptive motion estimation according to the present disclosure determine motion intensities of image blocks before motion estimations are performed on the image blocks. An estimate motion method is self-adaptively selected to estimate motion of the current image block according to the motion intensity of the current image block, which improves the efficiency of motion estimation in video encoding and decoding.

### BRIEF DESCRIPTION OF THE DRAWINGS

FIG. 1 is a schematic illustration of divided macro blocks and selections of coded image blocks adjacent to the current image block in video encoding and decoding.

FIG. 2 is an encoding block diagram adopted in a video encoding standard.

FIG. 3 illustrates a schematic view of a self-adaptive motion estimation module according to an implementation example of the present invention.

FIG. 4 illustrates a flowchart of a self-adaptive motion estimation method according to an implementation example of the present invention.

FIG. 5 is a schematic illustration of divided macro blocks and selections of coded image blocks adjacent to the current image block according to an implementation example of the present invention.

### DETAILED DESCRIPTION OF THE INVENTION

In the current mainstream video encoding and decoding standards (such as MPEG4, H.264/AVC and H.264/AVS) and related video processing applications (such as super-resolution and frame rate up-sampling), most motion estimation methods involve scanning image blocks in a two-dimensional video frame from up to down and from left to right to search for the corresponding motion vectors. When each image block is estimated, the motion vectors of the blocks in the left and upper regions adjacent to the image block are used as spatial predictive motion vectors. The motion vectors of the image blocks on the lower right to the corresponding image block in the previous frame are used as the temporal predictive motion vectors. Then a certain strategy is adopted to choose the most accurate one in the predictive motion vectors as the initial motion vector of the current image block. With this method, the first estimated motion vector can be transferred from the image blocks on the top left to the image blocks on the lower right in the order of scanning from up to down and from left to right, which refines the motion vector step by step.

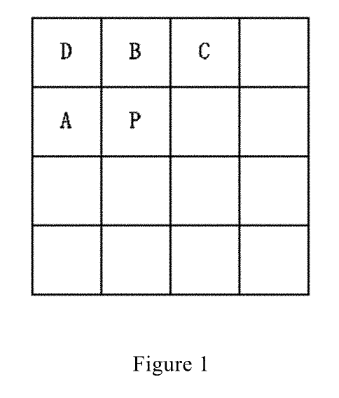

Referring to FIG. 1, an exemplified video frame is divided into macro blocks (image blocks) each having a fixed size and comprising 16*16 pixels. Image processing is in the following order: first, the image blocks of the first line are processed from left to right, followed by the second line, until the whole video frame is processed.

The image block P is assumed the current image block to be encoded. According to some embodiments of the present invention, when the current image block P is processed, the motion vector of the current image block is calculated with the motion vectors of the reference image blocks as reference values. Since each image block in the video frame is highly similar to its already coded adjacent image blocks, the coded adjacent image blocks of the current image block are selected as the reference image blocks in general. As shown in FIG. 1, the image blocks A, B, C, and D are the reference image blocks to the current image block P.

In some embodiments, in selecting reference image blocks, the adjacent upper image block, the upper right image block, and the adjacent left image block of the current image block may be selected as reference image blocks. For example, the reference image blocks to the current image block P in FIG. 1 can be image blocks A, B and C. If the upper right image block does not exist relative to the current image block (for example, when the current image block are in the first column on the right edge of an image) or when the image block C does not have any motion vector, the upper left image block of the current image block is selected instead. In the example shown in FIG. 1, the reference image blocks of the current image block P can then be image blocks A, B and D.

Therefore, in specific implementations, the adjacent image blocks of a current image block can be defined according to actual requirements.

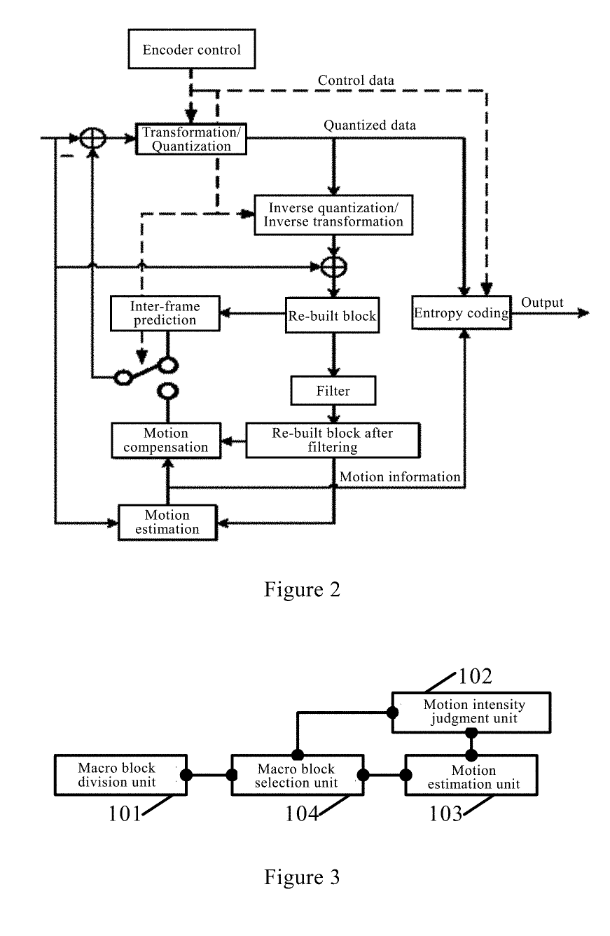

FIG. 2 shows an encoding block diagram for the current mainstream video encoding standards. An input video frame is divided into a number of macro blocks (image blocks). Then the intra-frame prediction (intra-frame encoding) or motion compensation (intra-frame encoding) is performed on the current image block. The encoding mode with the lowest encoding cost is selected by the mode decision process, to obtain so that the prediction block of the current image block. The residual differences between the current image block and the prediction blocks are obtained, and transformed, quantized, scanned, and entropy coded to form the output code stream. The encoding block diagram shown in FIG. 2 is well known to those skilled in the field and will not be described further herein.

In order to solve the problems of the existing technologies, the present invention discloses a context-based self-adaptive motion estimation method, which determines motion intensity of the current image block according to the motion information of the current image block and its coded adjacent image blocks. If the motion intensity is low, a motion estimation method with a high search speed is used. Otherwise, if the motion intensity is high, a more complex motion estimation method is used to improve accuracy. The common motion information includes predicted motion vectors, motion vectors, and motion vector differences of the image blocks.

The embodiments of the present invention are further described below with reference to the attached schematic drawings.

The present implementation example provides a method and a module of self-adaptive motion estimation in video encoding.

Referring to FIG. 3, a self-adaptive motion estimation module includes a macro block division unit 101, a macro block selection unit 104, a motion intensity judgment unit 102, and a motion estimation unit 103.

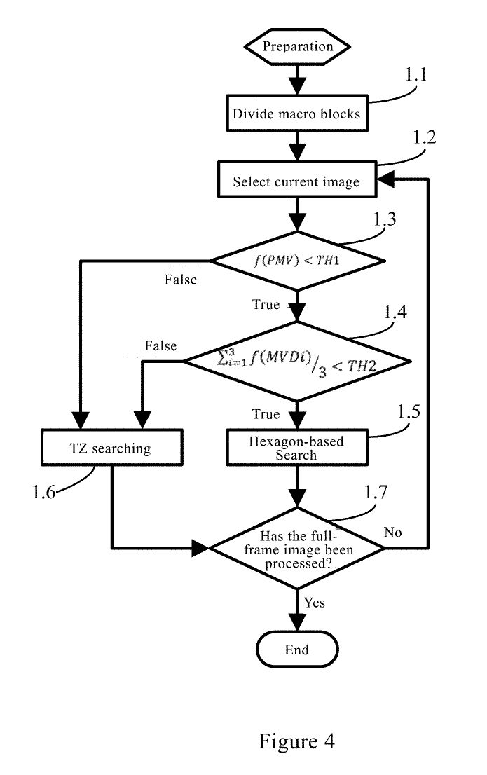

Referring to FIG. 4, a self-adaptive motion estimation method includes the following steps:

Step 1.1: a to-be-encoded video frame is divided into macro blocks by the macro block division unit 101.

Step 1.2: the macro block selection unit 104 sequentially selects image blocks in the video frame as the current image block for processing. In the present embodiment, the image blocks can be processed from left to right and from up to down.

After Step 1.2, the motion intensity judgment unit 102 determines a motion intensity of the current image block. In some embodiments, the motion intensity judgment unit 102 determines whether the motion intensity of the current image block satisfies a preset condition. If it does not, it is determined that the motion intensity of the current image block is high, and a first motion estimation method is selected. If the motion intensity of the current image block satisfies a preset condition, it is determined that the motion intensity of the current image block is low, and a second motion estimation method is selected. The motion intensity is used to characterize a motion amplitude and/or a motion frequency of an object in the video frame. For example, the higher the motion amplitude and/or the motion frequency, the more intense is the motion of the object in a video frame, and the higher the motion intensity that the current image block has. It is thus necessary to use a motion estimation method with high search accuracy for motion estimation of the current image (blocks). Otherwise (with low motion intensity), a motion estimation method with high search speed can be adopted for motion estimation of the current image (blocks). The present disclosed method and module can improve search speeds in motion estimation while ensuring accuracy of motion estimation, thus improving the overall efficiency of motion estimation.

In the present implementation example, the search speed of the second motion estimation method is higher than that of the first motion estimation method. In particular, the first motion estimation method can be implemented by the TZ (Test Zone) search algorithm that has low search speed but high accuracy, which is suitable for images with high motion intensity. The second motion estimation method can be implemented by the Hexagon-based Search algorithm that has low accuracy but high search speed, which is suitable for images with low motion intensity.

In some embodiments, the first motion estimation method and the second motion estimation method can be implemented by other search algorithms. The TZ search algorithm and the Hexagon-based Search algorithm are used only as illustration examples. Further, according to some embodiments of the present invention, the first motion estimation method and the second motion estimation method can respectively include multiple search algorithms. In video encoding, after selecting the first motion estimation method versus the second motion estimation method, an optimum algorithm is selected from the multiple search algorithms according to specific conditions for motion estimation of a particular image.

Further, in the present implementation example, the motion intensity of the current image block is determined by the motion intensity judgment unit 102 according to the motion information of the current image block and its coded adjacent image blocks. Further, the motion intensity of the current image block is determined by the motion intensity judgment unit 102 according to the motion vector difference (MVD) between the predictive motion vector (PMV) of the current image block and the motion vectors of adjacent already coded image blocks. In other words, in the present implementation, when the motion intensity of the current image block is determined by the motion intensity judgment unit 102 according to the motion information of the current image block and the coded adjacent image blocks, the motion information for the current image block is selected as the predicted motion vector of the current image block; and the motion information for the coded adjacent image blocks is selected as the motion vector difference of coded adjacent image blocks. In some embodiments, other parameters can be selected as the motion information for the current image block and the coded adjacent image blocks. For example, the motion vectors of coded adjacent image blocks can be selected as the motion information for the coded adjacent image blocks.

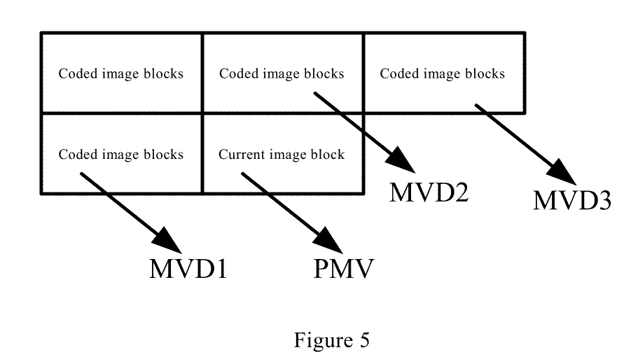

As shown in FIG. 5, the predictive motion vector of the current image block is PMV. The motion vector differences (MVD1, MVD2, MVD3) for the left, upper, and upper right coded adjacent image blocks are selected as reference for determining the motion intensity of the current image block. It should be noted that, if the upper right coded adjacent image blocks of the current image block is absent, the motion vector difference of the upper left coded adjacent image blocks can be selected as a reference. If the left coded adjacent image block to the current image block is absent, the motion vector difference of the upper or the upper right coded adjacent image block can be selected as a reference. If no coded adjacent image block is present or only the left coded adjacent image block to the current image block is present, the motion intensity of the current image block may not be performed, and a motion estimation method can be directly applied to estimate motion of the current image block without using motion intensity.

In the present implementation example, the motion intensity judgment unit 102 is tasked to determine whether the motion intensity of the current image block satisfies a preset condition. If so, it is determined that the motion intensity of the current image block is low. If not, it is determined that the motion intensity of the current image block is high.

f(PMV)<TH1 and Σᵢ₌₁³f(MVDi)/3<TH2

wherein TH1 and TH2 are two preset thresholds, and their values can be selected as needed; and f is a vector operation function. For example, f can be the square of the module of a vector to simplify the operation and to avoid the complex extraction of square root.

The predictive motion vector of the current image block is calculated using known information. The common calculation method includes selecting the median or the mean of the motion vector of the image block at the current position of the previous video frame and the motion vectors of coded adjacent image blocks to the current image block, or the motion vector of a single coded adjacent image block as the predicted motion vectors of the current image block. After the predictive motion vector is obtained, a more accurate motion vector is obtained via the motion estimation process, such as the TZ search algorithm or the Hexagon-based Search algorithm. The difference between the motion vector obtained via motion estimation and the predicted motion vector is obtained. In video encoding, the difference between the motion vector obtained by motion estimation and the predictive motion vector (motion vector difference) is recorded in the code stream, and the value of the motion vector difference is small or even 0. Therefore, the code rate can be saved, and smaller code stream is required for transmitting of the video.

Next, specific steps for determining the motion intensity of the current image block by the motion intensity judgment unit 102 is described.

Step 1.3: the motion intensity judgment unit 102 determines whether the current image block satisfies the following condition:

f(PMV)<TH1

If so, go to Step 1.4; if not, the motion intensity of the current image block is high, and go to Step 1.6.

Step 1.4: the motion intensity judgment unit 102 determines whether the current image block satisfies the following condition:

Σᵢ₌₁³f(MVDi)/3<TH2

If so, go to Step 1.5; if not, the motion intensity of the current image block is high, and go to Step 1.6.

Step 1.5: at this time, the motion intensity judgment unit 102 determines that the motion intensity of the current image block is low. Therefore, the Hexagon-based Search algorithm with a high search speed is selected for motion estimation for the current image block.

Step 1.6: at this time, the motion intensity judgment unit 102 determines that the motion intensity of the current image block is high. Therefore, the TZ (Test Zone) search algorithm with high search accuracy is selected for motion estimation for the current image block.

Step 1.7: determine whether the full video frame has been processed. If not, go to Step 1.2 and select the next image block as the current image block to continue processing. If so, the processing of the frame images ends.

A method and a module for self-adaptive motion estimation in video encoding is provided to calculate motion intensity of the current image block using context information (motion information of coded adjacent image blocks), and to adaptively adjust the method used for motion estimation, so as to reducing overall complexity and improving search speed without affecting the accuracy of motion estimation.

It will be understood by those skilled in the field that all or part of the various methods according to the embodiments may be programmed to instruct the associated hardware to achieve the goals, which may be stored in a computer-readable storage medium, e.g. read-only memory, random access memory, magnetic disks, or CDs.

The above contents are further detailed description of the present invention in connection with the disclosed embodiments. The invention is not limited to the embodiments referred to, but may be varied and modified by those skilled in the field without departing from the idea and scope of the present invention.

What is claimed is:

1. A method for self-adaptive motion estimation, comprising:
dividing a video frame to be encoded into macro blocks by a macro block division unit in a computer processing system;
sequentially selecting one of the image blocks in the video frame as a current image block by a macro block selection unit in the computer processing system;
determining a motion intensity of the current image block, and self-adaptively selecting a method to estimate motion of the current image block, by a motion intensity judgment unit, according to the motion intensity of the current image block, wherein the motion intensity characterizes a motion amplitude and/or a motion frequency of an object in the video frame; and
performing a motion estimation on the current image block by a motion estimation unit according to the method selected by the motion intensity judgment unit.

2. The method of claim 1, further comprising:
determining, by the motion intensity judgment unit, whether the motion intensity of the current image block satisfies a preset condition;
if the preset condition is not satisfied, determining that the motion intensity of the current image block is high, and selecting a first motion estimation method; and
if the preset condition is satisfied, determining that the motion intensity of the current image block is low, and selecting a second motion estimation method,
wherein the second motion estimation method has a higher search speed than the first motion estimation method.

3. The method of claim 1, wherein the motion intensity of the current image block is determined according to motion information of the current image block and coded image blocks adjacent to the current image block.

4. The method of claim 3, wherein the motion intensity of the current image block is determined according to a difference between a predicted motion vector of the current image block and a motion vector of an already coded image block adjacent to the current image block.

5. The method of claim 4, wherein the preset condition is expressed as:
f(PMV)<TH1 and Σᵢ₌₁³f(MVDi)/3<TH2
wherein TH1 and TH2 are preset thresholds, f is a vector operation function, PMV is a predicted motion vector of the current image block, and MVD is a difference between a predicted motion vector of the current image block and a motion vector of an already coded image block adjacent to the current image block.

6. A computer module for self-adaptive motion estimation, comprising:
a macro block division unit configured to divide a video frame to be encoded into macro blocks;
a macro block selection unit configured to sequentially select one of the image blocks in the video frame as a current image block;
a motion intensity judgment unit configured to determine a motion intensity of the current image block, and to self-adaptively select a method to estimate motion of the current image block according to the motion intensity of the current image block, wherein the motion intensity characterizes a motion amplitude and/or a motion frequency of an object in the video frame; and
a motion estimation unit configured to perform a motion estimation on the current image block according to the method selected by the motion intensity judgment unit.

7. The computer module of claim 6, wherein the motion intensity judgment unit is configured to determine whether the motion intensity of the current image block satisfies a preset condition, wherein if the preset condition is not satisfied, the motion intensity judgment unit is configured to determine that the motion intensity of the current image block is high, and selecting a first motion estimation method, wherein if the preset condition is satisfied, the motion intensity judgment unit is configured to determine that the motion intensity of the current image block is low, and selecting a second motion estimation method, wherein the second motion estimation method has a higher search speed than the first motion estimation method.

8. The computer module of claim 6, wherein the motion intensity of the current image block is determined by the motion intensity judgment unit according to motion information of the current image block and coded image blocks adjacent to the current image block.

9. The computer module of claim 8, wherein the motion intensity of the current image block is determined by the motion intensity judgment unit according to a difference between a predicted motion vector of the current image block and a motion vector of an already coded image block adjacent to the current image block.

10. The computer module of claim 9, wherein the preset condition is expressed as:
f(PMV)<TH1 and Σᵢ₌₁³f(MVDi)/3<TH2
wherein TH1 and TH2 are preset thresholds, f is a vector operation function, PMV is a predicted motion vector of the current image block, and MVD is a difference between a predicted motion vector of the current image block and a motion vector of an already coded image block adjacent to the current image block.
